(19) United States
(12) Patent Application Publication
(10) Pub. No.: US 2018/0130561 A1
(43) Pub. Date: May 10, 2018

(54) Systems, Devices, and/or Methods for Managing Radiation Shielding

(71) Applicant: Radium Incorporated, Waynesboro, VA (US)

(72) Inventor: Alfred Campbell Abernethy, Waynesboro, VA (US)

(73) Assignee: Radium Incorporated, Waynesboro, VA (US)

(21) Appl. No.: 15/804,871

(22) Filed: Nov. 6, 2017

Related U.S. Application Data
(60) Provisional application No. 62/418,261, filed on Nov. 6, 2016.

(51) Int. Cl. G21C 11/06; G21C 9/004; G21C 19/303; G21C 13/02

(52) U.S. Cl. CPC G21C 11/06; G21C 13/022; G21C 19/303; G21C 9/004

(57) ABSTRACT

Certain exemplary embodiments can provide a system that comprises a vessel in a nuclear fission system. The vessel defines a flanged access port. The system comprises a door assembly that is constructed to cover the flanged access port. The door assembly constructed to act as a radiation shield. The door is opened and closed via an actuating system.

### CROSS-REFERENCES TO RELATED APPLICATIONS

This application claims priority to, and incorporates by reference herein in its entirety, pending U.S. Provisional Patent Application Ser. No. 62/418,261 (Attorney Docket No. 2002-005), filed Nov. 6, 2016.

### BRIEF DESCRIPTION OF THE DRAWINGS

FIGS. 1-4 are executed in color

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000;

FIG. 2 is a perspective view of shield door assembly 1100 of system 1000 of FIG. 1 in a partially closed position;

FIG. 3 is a perspective view of shield door assembly 1100 of system 1000 of FIG. 1 in a substantially open position; and

FIG. 4 is a perspective view of system 1000, which shows airflows.

### DETAILED DESCRIPTION

Certain exemplary embodiments can provide a system that comprises a vessel in a nuclear fission system. The vessel defines a flanged access port. The system comprises a door assembly that is constructed to cover the flanged access port. The door assembly constructed to act as a radiation shield. The door is opened and closed via an actuating system.

Vessels such as steam generators in nuclear power plants need to be inspected or maintained on a regular basis. To gain access inside a steam generator for these activities, manway covers are typically removed. Because the steam generator is part of the nuclear power steam supply system, radioactive contamination can be present inside the steam generator. With the covers removed, radioactivity (e.g., gamma rays) can stream out of manway openings and radioactive contamination can become airborne and spread outside the manway opening with the system open.

If dose rates are high enough inside the steam generator, radiation protection personnel could post the area as Locked High Radiation Area (“LHRA”). Radiation protection personnel are required to control access to LHRA by the use of barriers and locks.

Certain exemplary radiation shield door systems can:
reduce streaming radiation coming from the manway opening;
effectively control the radioactive contamination inside the steam generator from exiting the manway opening; and/or
maintain a positive control (locked) of a Locked High Radiation Area.

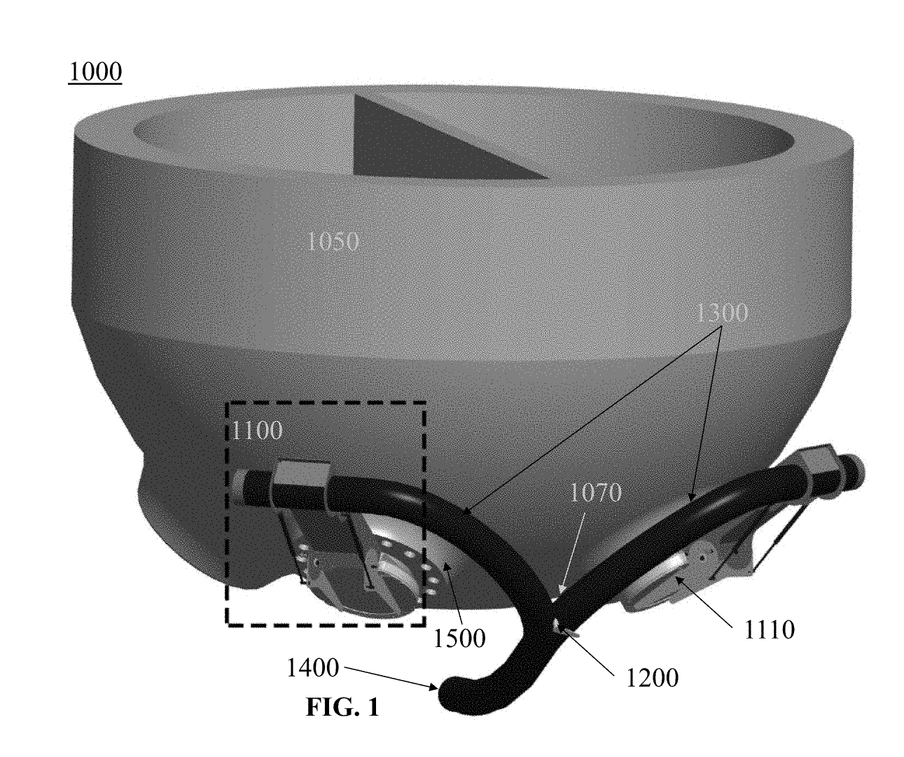

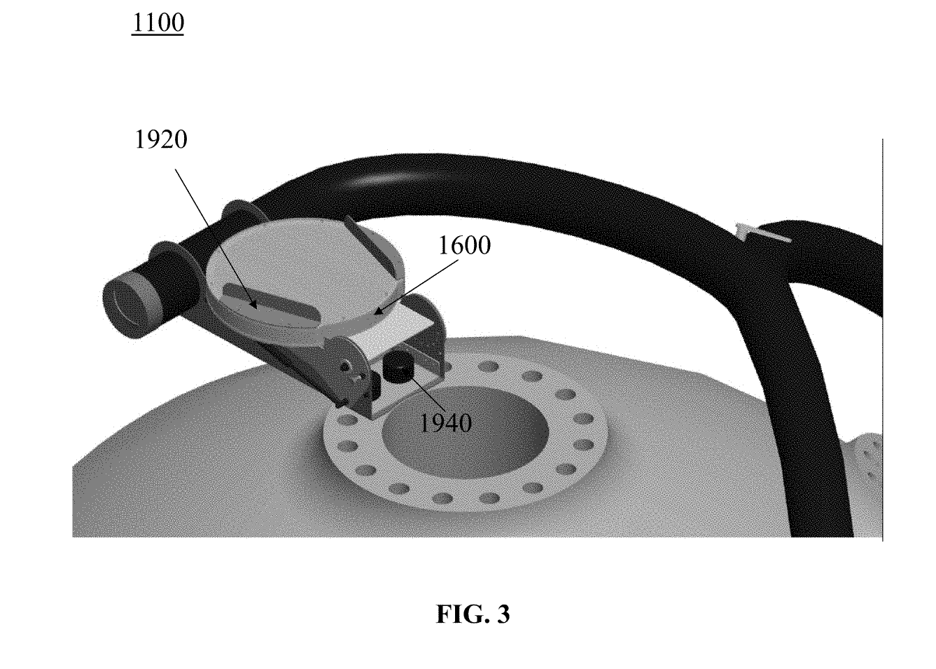

An exemplary Radiation Shield Door Assembly (see shield door assembly 1100 of FIG. 1) can be installed as a single assembly on the manway opening using a plurality of fasteners (e.g., via threaded fasteners such as bolts). The fasteners are part of the assembly (captured) and can utilize collapsible thread technology. With door 1600 in the open position (see FIG. 3), the installation can be substantially completed by a single person. The installer can align the captured bolts on the assembly with any designated two holes (paired) on the manway opening, push the door in place, the special bolt threads collapse and then expand to hold the assembly in place. The installer can then hand tighten the bolts to secure the assembly in place. These features minimize personnel and time to close the manway cover therefore minimizing personnel exposure. Alternatively, traditional threaded fasteners can also be used to secure the assembly, if desired.

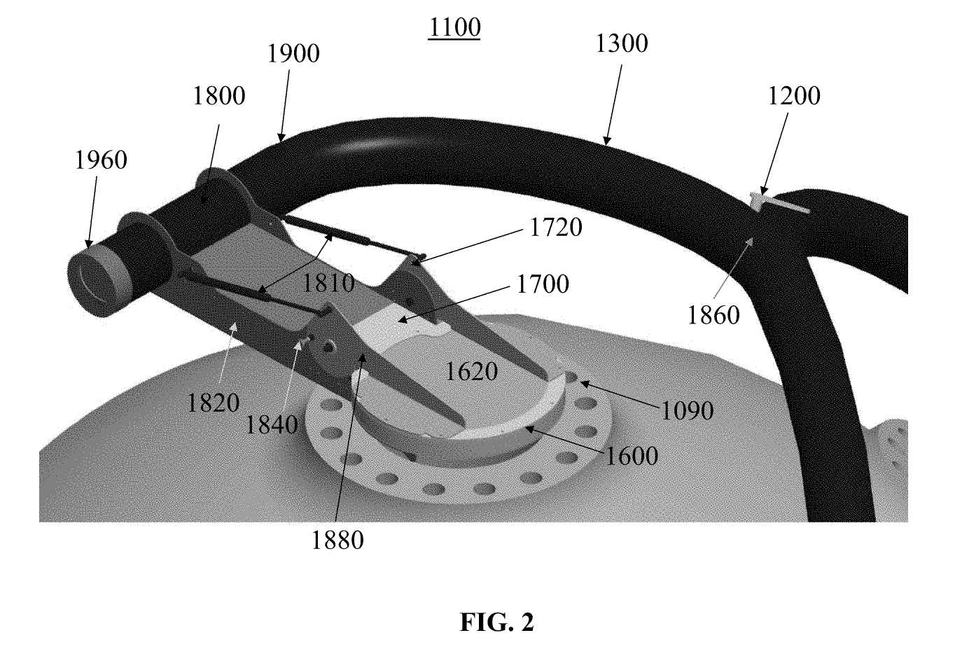

Once the assembly is secured in place, the door 1600 can be closed (as shown in FIG. 2) into place. Gas cylinders 1810 are used to help support the weight of the door 1600 in the open position (as shown in FIG. 3) or the closed position (as shown in FIG. 2). Lever locks 1840 are used to secure the door in a number of positions determined by the amount of maintenance cables and hoses entering the steam generator manway. The lever locks 1840 secure the door in place to prevent unauthorized access to a LHRA.

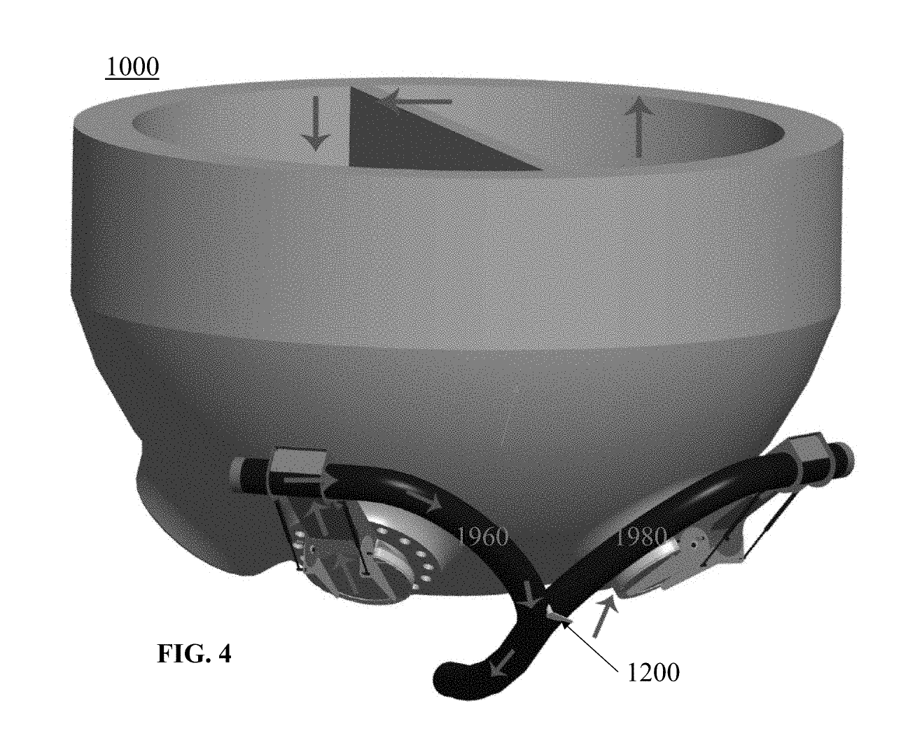

High-efficiency particulate air (“HEPA”) ventilation ducts 1300 can be connected to the ventilation tube 1800 (see FIG. 2) by clamps, cable ties, tape, or other means and then attached to the wye or splitter 1860 (see FIG. 2). HEPA vacuum source 1400 is connect to the base of the splitter 1860. A single damper lever 1200 directs the vacuum to either door if two doors are utilized as shown in FIG. 4. This feature keeps the HEPA hoses up and close to the steam generator and effectively increasing the working space in front of the shield door. It also eliminates regular removal of an HEPA hose for movement to the other door, and/or any connection of the HEPA hose when doors needed to be accessed (opened). Exemplary ventilation systems also keep accumulated radiation contamination in the ventilation ducts and/or hoses away from maintenance personnel (reducing the potential for personnel exposure) as compared to a front shield door mounted HEPA connection.

Moving HEPA hose connection 1900 to a position from a front shield door position, allows use of a shield 1620 (which can be substantially transparent) as a viewing port inside the steam generator. Opening and closing the door will not be required to view in this area, which is currently done with the referenced prior art doors. This feature reduces potential accumulated dose from constantly opening and closing the shield door.

The Radiation Shield Door System design was targeted for use on nuclear power plant steam generators manways but has uses and applications on other vessels, tanks, and other containers where radiation shielding, HEPA ventilation, and/or locked control over the area inside the vessel is desired.

Door 1600 (or an exemplary shield assembly) is weight assisted by gas cylinders 1810, springs, or other means for opening and/or supporting the door in the fully open position (FIG. 3) and closing and holding door 1600 up against the opening as shown in FIG. 2.

Integrated shield mount 1820 (see FIG. 2) and ventilation ducts 1300 are a relatively efficient combination of parts and causes ventilation ducts 1300 to be relocated off the door 1600.

Shield door assembly 1100 can be installed as a single piece by one person utilizing bolts 1940 (see integrated bolts in FIG. 3) that can use collapsible thread technology.

Door 1600 (or an exemplary shield assembly) can comprise a substantially transparent liquid shielding in a substantially transparent housing such as polycarbonate or substantially transparent solid shielding and be used as a view port into the vessel 1050, which can be a tank or container, etc. Substantially transparent liquid shielding can be in accordance with related pending U.S. patent application Ser. No. 15/709,244, which is incorporated by reference herein in its entirety.

Door 1600 (or an exemplary shield assembly) can be manufactured from lead, tungsten, or other shielding materials that are not transparent.

Door 1600 (or an exemplary shield assembly) can be manufactured as a single component or sectional to result in a relatively efficient utilization of parts.

When two shield door assemblies (shield door assembly 1100 and shield door assembly 1110) are installed on a single pressure vessel as shown in FIG. 1, a wye or splitter 1860 (see FIG. 2) can be installed between the two doors with interconnecting ventilation ducts 1300. The wye or splitter has a damper lever 1200 connected to a damper to select which door to pull air from HEPA vacuum source 1400 as shown in FIG. 1.

Air guides 1920 (see FIG. 3) on door 1600 have dual function for directing air from inside vessel 1050 and to prevent access into an area around the vessel's flanged access portal 1500 where door 1600 is installed.

Air guides 1920 (see FIG. 3) are positionable based on door installation position.

Door opening can be variable and locked in position by lever locks 1840 on the shield support arms 1880 (see FIG. 2).

Shield door assembly 1100 can be positioned using any pair of holes around the vessel's flanged access portal 1500.

HEPA hose connection 1900 (see FIG. 3) and end cap 1960 (see FIG. 3) on upper ventilation tube 1800 (see FIG. 3) can be interchangeable based on installation position.

With door 1600 in the closed position against flanged access portal 1500, the door 1600 covers bolts 1940 and substantially prevents access and removal of bolts 1940 in this position.

HEPA hose connection 1900 can be made once during an initial installation of shield door assembly 1100 and would generally not need to be relocated to another door 1600 when access is to other door 1600 desired.

FIG. 1 is a perspective view of an exemplary embodiment of a system 1000.

FIG. 2 is a perspective view of shield door assembly 1100 of system 1000 of FIG. 1 in a partially closed position.

FIG. 3 is a perspective view of shield door assembly 1100 of system 1000 of FIG. 1 in a substantially open position.

FIG. 4 is a perspective view of system 1000, which shows airflows.

Certain exemplary embodiments comprise a system 1000, which comprises;
a vessel 1050 in a nuclear fission system; wherein vessel 1040 defines a flanged access portal 1500; and
a shield door assembly 1100 that is constructed to cover flanged access portal 1500; wherein:
   shield door assembly 1100 is constructed to act as a radiation shield; and
   door 1600 of shield door assembly 1100 is opened and closed via an actuating system 1720.

Actuating system 1720 can comprise a gas cylinder 1810, a hydraulic cylinder (which can replace gas cylinder 1810), and/or a spring (which can replace gas cylinder 1810).

Shield door assembly 1100 can comprise an integrated shield mount 1700 and a ventilation tube 1800. Integrated shield mount 1700 can be coupleable to actuators (e.g., gas cylinder 1810) of actuating system 1720. Ventilation tube 1800 is constructed to remove air in proximity to shield door assembly 1100.

Shield door assembly 1100 can be is installable as a single piece by one person utilizing bolts 1940, which can be integrated bolts that use collapsible thread technology. Shield door assembly 1100 can comprise a shield 1620. Shield 1620 can comprise substantially transparent liquid shielding in a substantially transparent housing. Shield 1620 can comprise lead, tungsten, or other substantially opaque shielding material. Shield 1620 can be manufactured as a single or sectional component.

System 1000 can comprise a plurality of door assemblies (see, e.g., shield door assembly 1100 and door assembly 1110 of FIG. 1) and a wye or splitter 1860 is installed between doors with interconnecting ventilation ducts 1300. Wye or splitter 1860 can have a damper lever 1200 coupled to a damper to select which door to pull air from.

Shield door assembly 1100 is coupled to a ventilation system 1070. Ventilation system 1070 comprises air guides 1920 on a shield 1620 of shield door assembly 1100. Air guides 1920 have dual function for directing air from inside vessel 1050 and to prevent access into an area in proximity to shield door assembly 1100. Air guides 1920 can be positionable based on an installation position of shield door assembly 1100. Shield door assembly 1100 is locked in position by lever locks 1840 on shield support arms 1880.

Shield door assembly 1100 is positioned using any pair of apertures around a flange 1090 of the flanged access portal 1500. HEPA hose connection 1900 and end cap 1960 on ventilation tube 1800 can be interchangeable based on installation position. A ventilation portion of shield door assembly 1100 substantially covers at least one bolt (e.g., bolts 1940) coupling shield door assembly 1100 to vessel 1050. Thereby access is substantially prevented for removal of at least one bolt (e.g., bolts 1940). HEPA hose connection 1900 is made only once during installation of shield door assembly 1100 and does not need to be moved to another shield door when access is desired.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—a way of entry.
act—to perform a function.
activity—an action, act, step, and/or process or portion thereof
actuate—to put into mechanical motion.
actuator—a mechanical device that uses energy to produce a force in a reciprocating linear motion.
adapter—a device used to effect operative compatibility between different parts of one or more pieces of an apparatus or system.
air guide—a plate or object that acts to direct a direction of flow for air.
and/or—either in conjunction with or in alternative to.
apparatus—an appliance or device for a particular purpose.
area—a region and/or volume.
associate—to join, connect together, and/or relate.
bolt—a fastener with helical threads.
can—is capable of, in at least some embodiments.
cause—to produce an effect.
close—to cover an aperture.
collapsible thread technology—fasteners comprising threaded segments that are collapsible in an installer's hand by squeezing the bolt (i.e., via a double-action of pulling and pressing against the palm of the installer's hand). This allows the fasteners to be installed or removed relatively quickly. Once the threaded segments are fully extended, they are locked into place and the bolt can be tightened or loosened as desired.
comprising—including but not limited to.
configure—to make suitable or fit for a specific use or situation.
connect—to join or fasten together.
constructed to—made suitable or fit for a specific use or situation.
convert—to transform, adapt, and/or change.
couple—to link in some fashion.
coupleable—capable of being joined, connected, and/or linked together.
cover—to put something over a portal to substantially prevent passage through the portal.
create—to bring into being.
damper—a movable plate in duct work, the adjustment of which regulates airflow in the duct work.
damper lever—a rod or bar that is constructed to vary airflow in one or more branches of ventilation duct work.
define—to establish the outline, form, or structure of
determine—to obtain, calculate, decide, deduce, and/or ascertain.
device—a machine, manufacture, and/or collection thereof.
direct—to control, manage, and/or govern.
dual function—performs two distinct activities.
flange—a projecting rim from a vessel that defines an aperture for accessing an internal portion of the vessel; the rim defining a plurality of apertures to which a door can be fastened to cover the aperture for accessing the internal portion of the vessel.
gas cylinder—a mechanical device that uses energy from a compressed gas to produce a force in a reciprocating linear motion.
HEPA—something meeting US government high efficiency particulate air standards.
hose connection—a coupling usable to join two or more ventilation tubes.
hydraulic cylinder—a mechanical device that uses energy from a pressurized liquid to produce a force in a reciprocating linear motion.
install—to connect or set in position and prepare for use.
installation position—a location at which something is operatively coupled to a system (e.g., a door installed to substantially cover a port).
integrated bolt—a threaded fastener that has one end embedded in an object such that helical threads protrude from the object.
integrated shield mount—a system that is couplable to a door assembly and an actuating system therefor.
interchangeable—capable of being switched or substituted one for another.
interconnecting ventilation ducts—tubes through which ventilation airflows that are coupled to each such that ventilation airflow can be varied through one or more branches thereof
lever locks—a rod or bar that functions as a lock on a door assembly.
lock—a mechanism for keeping a door and/or lid, etc. fastened.
may—is allowed and/or permitted to, in at least some embodiments.
method—a process, procedure, and/or collection of related activities for accomplishing something.
nuclear fission—a process in which the nucleus of an atom splits into smaller parts, which releases energy.
opaque shielding material—a substance that reflects and/or absorbs ionizing radiation that cannot be seen through by a human.
open—to uncover an aperture.
plurality—the state of being plural and/or more than one.
portal—an opening for the insertion and/or passage of something (e.g., a part, a human, and/or a fluid, etc.).
position (n)—a particular location.
position (v)—to place in a particular location.
positionable—capable of being placed in a particular location.
predetermined—established in advance.
prevent access—to substantially restrict a human from accessing a location or area.
provide—to furnish, supply, give, and/or make available.
proximity—near in location.
pull—to draw air via suction.
radiation shield—a device and/or system that reflects or absorbs ionizing radiation.
receive—to get as a signal, take, acquire, and/or obtain.
remove—to move from a place or position occupied.
repeatedly—again and again; repetitively.
request—to express a desire for and/or ask for.
sectional—a section or subdivision of a larger whole.
select—to make a choice or selection from alternatives.
set—a related plurality.
shield—a piece of material that reflects and/or absorbs ionizing radiation.
arm—something that projects from a larger structure.
single piece—substantially only one component.
splitter—a fork in duct work that is constructed to allow ventilation airflows to be adjusted via one or more dampers, gates, and/or valves, etc.
spring—a helical metal coil or functional equipment that, that can be pressed or pulled but returns to its former shape when released.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
transparent housing—a structure that comprises a shielding material that a human can see through.
transparent liquid shielding—a material that a human can see through that that reflects and/or absorbs ionizing radiation.
ventilation—a movement of air from a first area to a second area.
ventilation duct—a conduit or passage used to collect and remove air that comprises radiation.
vessel—a container or tank that holds something.
via—by way of and/or utilizing.
weight—a value indicative of importance.
wye—duct work that is shaped like a “Y”.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a vessel in a nuclear fission system, the vessel defining a flanged access portal; and
a door assembly that is constructed to cover the flanged access portal, the door assembly constructed to act as a radiation shield, a door of the door assembly opened and closed via an actuating system.

2. The system of claim 1, wherein:
the actuating system comprises a gas cylinder.

3. The system of claim 1, wherein:
the actuating system comprises a hydraulic cylinder.

4. The system of claim 1, wherein:
the actuating system comprises a spring.

5. The system of claim 1, wherein:
the door assembly comprises an integrated shield mount and a ventilation duct, the integrated shield mount couplable to actuators of the actuating system, the ventilation duct constructed to remove air in proximity to the door assembly.

6. The system of claim 1, wherein:
the door assembly is installable as a single piece by one person utilizing integrated bolts that use collapsible thread technology.

7. The system of claim 1, wherein:
the door assembly comprises a shield, the shield comprising substantially transparent liquid shielding in a substantially transparent housing.

8. The system of claim 1, wherein:
the door assembly comprises a shield, the shield comprising lead, tungsten, or other substantially opaque shielding material.

9. The system of claim 1, wherein:
the door assembly comprises a shield, the shield is manufactured as a single or sectional component.

10. The system of claim 1, wherein:
the system comprises a plurality of door assemblies and a wye or splitter is installed between doors with interconnecting ventilation ducts; and
the wye or splitter has a damper lever coupled to a damper to select which door to pull air from.

11. The system of claim 1, wherein:
the door assembly is coupled to a ventilation system, the ventilation system comprising air guides on a shield of the door assembly that have dual function for directing air from inside the vessel and to prevent access into an area in proximity to the door assembly.

12. The system of claim 1, wherein:
the door assembly is coupled to a ventilation system, the ventilation system comprising air guides on a shield of the door assembly, the air guides positionable based on an installation position of the door assembly.

13. The system of claim 1, wherein:
the door assembly is locked in position by lever locks on shield support arms.

14. The system of claim 1, wherein:
the door assembly is positioned using any pair of apertures around a flange of the flanged access portal.

15. The system of claim 1, wherein:
a hose connection and end cap on a ventilation tube are interchangeable based on installation position.

16. The system of claim 1, wherein:
a ventilation portion of the door assembly substantially covers at least one bolt coupling the door assembly to the vessel and thereby prevent access and removal of the at least one bolt.

17. The system of claim 1, wherein:
a HEPA hose connection is made only once during installation of the door assembly and does not need to be moved to another shield door when access is desired.
